(19) United States
(12) Patent Application Publication
(10) Pub. No.: US 2024/0336514 A1
(43) Pub. Date: Oct. 10, 2024

(54) GLASS

(71) Applicant: AGC Inc., Tokyo (JP)

(72) Inventors: Shigeki Sawamura, Tokyo (JP); Naoki Kanno, Tokyo (JP)

(73) Assignee: AGC Inc., Tokyo (JP)

(21) Appl. No.: 18/743,904

(22) Filed: Jun. 14, 2024

Related U.S. Application Data
(63) Continuation of application No. PCT/JP2022/046398, filed on Dec. 16, 2022.

(30) Foreign Application Priority Data
Dec. 20, 2021 (JP) 2021-206532

(51) Int. Cl. C03C 3/19; C03C 3/066; C03C 3/068; C03C 3/21; C03C 4/00; G02B 1/00

(52) U.S. Cl. CPC C03C 3/19; C03C 3/066; C03C 3/068; C03C 3/21; C03C 4/0092; G02B 1/00; C03C 2204/00

(57) ABSTRACT

Provided is glass having a high refractive index and a high transmittance and capable of being appropriately molded. Glass (10) contains, in weight percentage on an oxide basis: Bi₂O₃: 5.0% to 80.0%; B₂O₃: 1.0% to 15.0%; TiO₂: 0% to 7.0%; Nb₂O₅: 0% to 17.0%; and TeO₂: 0% to 30.0%, in which a content of (Li₂O+Na₂O+K₂O) is 0% to 5.0%.

### CROSS-REFERENCE TO RELATED APPLICATIONS

This application is a Bypass Continuation of International Application No. PCT/JP2022/046398, filed on Dec. 16, 2022, which claims priority to Japanese Patent Application No. 2021-206532, filed on Dec. 20, 2021. The entire contents of which are incorporated herein by reference.

### FIELD

The present invention relates to glass.

### BACKGROUND

In recent years, there is a demand for glass having a high refractive index and a high transmittance. Particularly, for example, in wearable devices such as a head-mounted display that implements Augmented Reality (AR), Virtual Reality (VR), Mixed Reality (MR), and the like, a light guide plate is required to have a high refractive index property and a high transmittance property with respect to visible light. For example, Patent Literature 1 describes an optical glass having a high refractive index and a high transmittance.

### CITATION LIST

### Patent Literature

Patent Literature 1: JP 5682171 B2

### SUMMARY

### Technical Problem

However, there is room for improvement in a transmittance property of the optical glass of Patent Literature 1. For example, press molding may be performed in order to manufacture a glass substrate having a large area, and it is also required to appropriately perform a molding process such as press molding.

The present invention has been made in view of the above problems, and an object thereof is to provide glass having a high refractive index and a high transmittance and capable of being appropriately molded.

### Solution to Problem

To solve the problem above, a glass of the present disclosure comprises, in weight percentage on an oxide basis:
Bi₂O₃: 5.0% to 80.0%;
B₂O₃: 1.0% to 15.0%;
TiO₂: 0% to 7.0%;
Nb₂O₅: 0% to 17.0%; and
TeO₂: 0% to 30.0%, wherein
a content of (Li₂O+Na₂O+K₂O) is 0% to 5.0%.

According to the present disclosure, it is possible to provide glass having a high refractive index and a high transmittance and capable of being appropriately molded.

### BRIEF DESCRIPTION OF DRAWINGS

FIG. 1 is a schematic view of glass according to the present embodiment.

FIG. 2 is a cross-sectional view assuming that the glass according to the present embodiment is a glass plate.

### DESCRIPTION OF EMBODIMENTS

The following describes a preferred embodiment of the present invention in detail with reference to the attached drawings. The present invention is not limited to the embodiment, and in a case in which there are a plurality of embodiments, the embodiments may be combined with each other. Numerical values encompass rounded numerical values.

### (Glass)

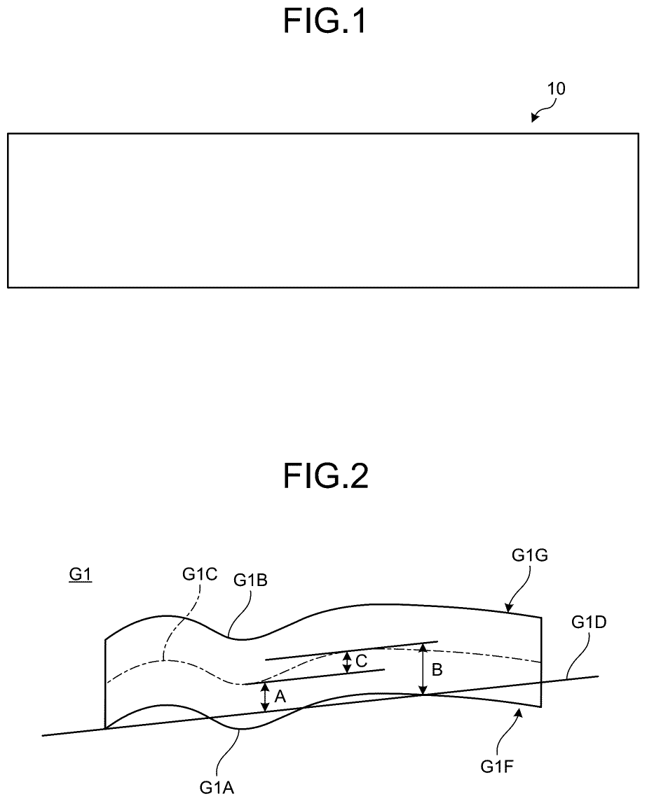

FIG. 1 is a schematic view of glass according to the present embodiment. As illustrated in FIG. 1, glass 10 according to the present embodiment is a glass plate having a plate shape, but the shape of the glass 10 is not limited to the plate shape and may be optional. In the present embodiment, the glass 10 is used as a light guide plate. More specifically, the glass 10 is used as a light guide plate for a head-mounted display. The head-mounted display is a display device (wearable device) mounted on a person's head. However, a use of the glass 10 is optional, and the glass 10 is not necessarily used as a light guide plate, and is not necessarily used for a head-mounted display.

### (Glass Composition)

The following describes the composition of the glass 10.

(Bi₂O₃)

Bi₂O₃ can greatly improve a refractive index while lowering a glass transition temperature Tg, but when this component is contained in a large amount, not only the production characteristics are deteriorated but also the transmittance is lowered. Therefore, in the glass 10, in weight percentage on an oxide basis, a content of Bi₂O₃ is 5.0% or more, preferably 10.0% or more, more preferably 15.0% or more, and still more preferably 20.0% or more. When a lower limit value of Bi₂O₃ is in this range, a high refractive index is achieved, which is preferable. In the glass 10, in weight percentage on an oxide basis, the content of Bi₂O₃ is 80.0% or less, preferably 78.0% or less, and more preferably 76.0% or less. When an upper limit value of Bi₂O₃ is in this range, a high transmittance is achieved, which is preferable.

That is, it can be said that in the glass 10, in weight percentage on an oxide basis, the content of Bi₂O₃ is 5.0% or more and 80.0% or less, preferably 10.0% or more and 78.0% or less, more preferably 15.0% or more and 77.0% or less, further preferably 20.0% or more and 76.0% or less, and further preferably 57.0% or more and 75.1% or less. When the content of Bi₂O₃ is in this range, the glass 10 can have a high refractive index while maintaining a high transmittance with respect to visible light.

Herein, the content indicates a weight percentage of a content of oxide assuming that a weight percentage of a total amount of the glass 10 is 100% in weight percentage on an oxide basis. That is, for example, “the content of Bi₂O₃ is 5.0% or more” means that the content of Bi₂O₃ is 5.0% or more assuming that the weight percentage of the total amount of the glass 10 is 100% in weight percentage on an oxide basis.

(B₂O₃)

B₂O₃ is a glass-forming component and is a component contributing to improvement of the stability of the glass and improving the production characteristics, but when this component is contained in a large amount, the refractive index tends to decrease. Therefore, in the glass 10, in weight percentage on an oxide basis, a content of B₂O₃ is 1.0% or more, preferably 2.0% or more, and more preferably 3.0% or more. When a lower limit value of B₂O₃ is in this range, stability of the glass can be maintained, which is preferable. In the glass 10, in weight percentage on an oxide basis, the content of B₂O₃ is 15.0% or less, preferably 13.0% or less, and more preferably 11.0% or less. When an upper limit value of B₂O₃ is in this range, a high refractive index is achieved, which is preferable.

That is, it can be said that in the glass 10, in weight percentage on an oxide basis, the content of B₂O₃ is 1.0% or more and 15.0% or less, preferably 2.0% or more and 13.0% or less, more preferably 3.0% or more and 11.0% or less, and further preferably 5.9% or more and 10.4% or less. When the content of B₂O₃ is in this range, the glass 10 can have a high refractive index while maintaining a high transmittance with respect to visible light.

### (TiO₂)

TiO₂ is a high refractive index component, but when this component is contained in a large amount, the internal transmittance of the glass is lowered. Therefore, in the glass 10, in weight percentage on an oxide basis, a content of TiO₂ is 0% or more, preferably 0.2% or more, and more preferably 0.3% or more. In the glass 10, in weight percentage on an oxide basis, the content of TiO₂ is 7.0% or less, preferably 5.0% or less, and more preferably 3.0% or less. When an upper limit value of TiO₂ is in this range, a high transmittance is achieved, which is preferable.

That is, it can be said that in the glass 10, in weight percentage on an oxide basis, the content of TiO₂ is 0% or more and 7.0% or less, preferably 0.2% or more and 5.0% or less, more preferably 0.3% or more and 3.0% or less, and further preferably 0% or more and 1.1% or less. When the content of TiO₂ is in this range, the glass 10 can have a high refractive index while maintaining a high transmittance with respect to visible light. However, the glass 10 may not contain TiO₂.

(Nb₂O₅)

Nb₂O₅ is a component increasing the refractive index of the glass and is a component improving mechanical characteristics, but when this component is contained in a large amount, the glass is easy to devitrify, and the production characteristics are deteriorated. Therefore, in the glass 10, in weight percentage on an oxide basis, a content of Nb₂O₅ is 0% or more, preferably 0.5% or more, and more preferably 1.0% or more. In the glass 10, in weight percentage on an oxide basis, the content of Nb₂O₅ is 17.0% or less, preferably 15.0% or less, and more preferably 13.0% or less.

That is, it can be said that in the glass 10, in weight percentage on an oxide basis, the content of Nb₂O₅ is 0% or more and 17.0% or less, preferably 0.5% or more and 15.0% or less, more preferably 1.0% or more and 13.0% or less, and further preferably 1.6% or more and less than 7.7%. When the content of Nb₂O₅ is in this range, the glass 10 can have a high refractive index while maintaining a high transmittance with respect to visible light. However, the glass 10 may not contain Nb₂O₅.

### (TeO₂)

TeO₂ is a component contributing to an increase in refractive index while promoting vitrification. On the other hand, when this component is contained in a large amount, the mechanical characteristics of the glass are deteriorated. Therefore, in the glass 10, in weight percentage on an oxide basis, a content of TeO₂ is 0% or more, preferably 0.3% or more, and more preferably 1.0% or more. In the glass 10, in weight percentage on an oxide basis, the content of TeO₂ is 30.0% or less, preferably 27.0% or less, and more preferably 25.0% or less.

That is, it can be said that in the glass 10, in weight percentage on an oxide basis, the content of TeO₂ is 0% or more and 30.0% or less, preferably 0.3% or more and 27.0% or less, more preferably 1.0% or more and 25.0% or less, and further preferably 1.49% or more and 19.6% or less. When the content of TeO₂ is in this range, the glass 10 can have a high refractive index while maintaining a high transmittance with respect to visible light. However, the glass 10 may not contain TeO₂.

### (Li₂O)

Li₂O is a component capable of lowering the glass transition temperature Tg while improving the mechanical properties of the glass. On the other hand, when this component is contained in an excessively large amount, the glass is easy to devitrify, and the production characteristics are deteriorated. Therefore, in the glass 10, in weight percentage on an oxide basis, a content of Li₂O is preferably 0% or more, more preferably 0.05% or more, and further preferably 0.10% or more. In the glass 10, in weight percentage on an oxide basis, the content of Li₂O is preferably 5.0% or less, more preferably 3.0% or less, and further preferably 1.5% or less.

That is, it can be said that in the glass 10, in weight percentage on an oxide basis, the content of Li₂O is preferably 0% or more and 5.0% or less, more preferably 0.05% or more and 3.0% or less, further preferably 0.10% or more and 1.5% or less, and further preferably 0% or more and 1.39% or less. When the content of Li₂O is in this range, the glass 10 can have a high refractive index while maintaining a high transmittance with respect to visible light. However, the glass 10 may not contain Li₂O.

### (Na₂O)

Na₂O is a component capable of lowering the glass transition temperature Tg of the glass. On the other hand, when this component is contained in an excessively large amount, chemical durability is deteriorated. Therefore, in the glass 10, in weight percentage on an oxide basis, a content of Na₂O is preferably 0% or more, more preferably 0.05% or more, and further preferably 0.10% or more. In the glass 10, in weight percentage on an oxide basis, the content of Na₂O is preferably 5.0% or less, more preferably 3.0% or less, and further preferably 1.0% or less.

That is, it can be said that in the glass 10, in weight percentage on an oxide basis, the content of Na₂O is preferably 0% or more and 5.0% or less, more preferably 0.05% or more and 3.0% or less, further preferably 0.10% or more and 1.0% or less, and further preferably 0% or more and 0.13% or less. When the content of Na₂O is in this range, the glass 10 can have a high refractive index while maintaining a high transmittance with respect to visible light. However, the glass 10 may not contain Na₂O.

### (K₂O)

K₂O is a component improving the meltability of the glass, but when this component is contained in an excessively large amount, chemical durability is deteriorated. Therefore, in the glass 10, in weight percentage on an oxide basis, a content of K₂O is preferably 0% or more, more preferably 0.01% or more, and further preferably 0.10% or more. In the glass 10, in weight percentage on an oxide basis, the content of K₂O is preferably 3.0% or less, more preferably 1.5% or less, and further preferably 1.0% or less.

That is, it can be said that in the glass 10, in weight percentage on an oxide basis, the content of K₂O is preferably 0% or more and 3.0% or less, more preferably 0.01% or more and 1.5% or less, further preferably 0.10% or more and 1.0% or less, and further preferably 0% or more and 0.2% or less. When the content of K₂O is in this range, the glass 10 can have a high refractive index while maintaining a high transmittance with respect to visible light. However, the glass 10 may not contain K₂O.

### (ZrO₂)

ZrO₂ is a component capable of improving mechanical properties while improving a refractive index, but when this component is contained in an excessively large amount, the glass is easy to devitrify, and the production characteristics are deteriorated. Therefore, in the glass 10, in weight percentage on an oxide basis, a content of ZrO₂ is preferably 0% or more, more preferably 0.1% or more, and further preferably 0.5% or more. In the glass 10, in weight percentage on an oxide basis, the content of ZrO₂ is preferably 10.0% or less, more preferably 7.0% or less, and further preferably 5.0% or less.

That is, it can be said that in the glass 10, in weight percentage on an oxide basis, the content of ZrO₂ is 0% or more and 10.0% or less, more preferably 0.1% or more and 7.0% or less, further preferably 0.5% or more and 5.0% or less, and further preferably 0% or more and 2.8% or less. When the content of ZrO₂ is in this range, the glass 10 can have a high refractive index while maintaining a high transmittance with respect to visible light. However, the glass 10 may not contain ZrO₂.

(Ta₂O₅)

Ta₂O₅ is a component capable of increasing a refractive index, but when this component is contained in an excessively large amount, the glass is easy to devitrify, and the production characteristics are deteriorated. Therefore, in the glass 10, in weight percentage on an oxide basis, a content of Ta₂O₅ is preferably 0% or more, more preferably 0.1% or more, and further preferably 0.3% or more. In the glass 10, in weight percentage on an oxide basis, the content of Ta₂O₅ is preferably 5.0% or less, more preferably 4.0% or less, and further preferably 3.0% or less.

That is, it can be said that in the glass 10, in weight percentage on an oxide basis, the content of Ta₂O₅ is preferably 0% or more and 5.0% or less, more preferably 0.1% or more and 4.0% or less, further preferably 0.3% or more and 3.0% or less, and further preferably 0% or more and 1.87% or less. When the content of Ta₂O₅ is in this range, the glass 10 can have a high refractive index while maintaining a high transmittance with respect to visible light. However, the glass 10 may not contain Ta₂O₅.

### (WO₃)

WO₃ is a component capable of increasing the refractive index of the glass, but when this component is contained in an excessively large amount, not only the internal transmittance decreases but also the glass is easy to devitrify. Therefore, in the glass 10, in weight percentage on an oxide basis, a content of WO₃ is preferably 0% or more, more preferably 0.05% or more, and further preferably 0.1% or more. In the glass 10, in weight percentage on an oxide basis, the content of WO₃ is preferably 5.0% or less, more preferably 3.0% or less, and further preferably 2.0% or less.

That is, it can be said that in the glass 10, in weight percentage on an oxide basis, the content of WO₃ is preferably 0% or more and 5.0% or less, more preferably 0.05% or more and 3.0% or less, further preferably 0.1% or more and 2.0% or less, and further preferably 0% or more and 0.3% or less. When the content of WO₃ is in this range, the glass 10 can have a high refractive index while maintaining a high transmittance with respect to visible light. However, the glass 10 may not contain WO₃.

### (SiO₂)

SiO₂ is a component capable of stabilizing the glass, but when this component is contained in a large amount, not only the refractive index decreases but also the raw material is hardly melted. Therefore, in the glass 10, in weight percentage on an oxide basis, a content of SiO₂ is preferably 0% or more, more preferably 0.1% or more, and further preferably 0.5% or more. In the glass 10, in weight percentage on an oxide basis, the content of SiO₂ is preferably 10.0% or less, more preferably 7.0% or less, and further preferably 5.0% or less.

That is, it can be said that in the glass 10, in weight percentage on an oxide basis, the content of SiO₂ is preferably 0% or more and 10.0% or less, more preferably 0.1% or more and 7.0% or less, further preferably 0.5% or more and 5.0% or less, and further preferably 0% or more and 3.92% or less. When the content of SiO₂ is in this range, the glass 10 can have a high refractive index while maintaining a high transmittance with respect to visible light. However, the glass 10 may not contain SiO₂.

(P₂O₅)

P₂O₅ is a glass-forming component and stabilizes the glass. On the other hand, when this component is contained in an excessively large amount, the refractive index decreases. Therefore, in the glass 10, in weight percentage on an oxide basis, a content of P₂O₅ is preferably 0% or more, more preferably 0.1% or more, and further preferably 1.0% or more. In the glass 10, in weight percentage on an oxide basis, the content of P₂O₅ is preferably 10.0% or less, more preferably 9.0% or less, and further preferably 8.0% or less.

That is, it can be said that in the glass 10, in weight percentage on an oxide basis, the content of P₂O₅ is 0% or more and 10.0% or less, more preferably 0.1% or more and 9.0% or less, further preferably 1.0% or more and 8.0% or less, and further preferably 2.0% or more and 6.8% or less. When the content of P₂O₅ is in this range, the glass 10 can have a high refractive index while maintaining a high transmittance with respect to visible light. However, the glass 10 may not contain P₂O₅.

(Li₂O+Na₂O+K₂O)

In the glass 10, in weight percentage on an oxide basis, (Li₂O+Na₂O+K₂O), that is, a total content of Li₂O, Na₂O, and K₂O is 0% or more, preferably 0.1% or more, and more preferably 0.3% or more. In the glass 10, in weight percentage on an oxide basis, (Li₂O+Na₂O+K₂O) is 5.0% or less, preferably 4.0% or less, and more preferably 3.0% or less.

That is, it can be said that in the glass 10, in weight percentage on an oxide basis, (Li₂O+Na₂O+K₂O) is 0% or more and 5.0% or less, preferably 0.1% or more and 4.0% or less, and more preferably 0.3% or more and 3.0% or less. When (Li₂O+Na₂O+K₂O) is in this range, the glass 10 can have a high refractive index while maintaining a high transmittance with respect to visible light. However, the glass 10 may not contain at least one of Li₂O, Na₂O, and K₂O.

(ZrO₂+Nb₂O₅+Ta₂O₅+WO₃)

In the glass 10, in mole percentage on an oxide basis, (ZrO₂+Nb₂O₅+Ta₂O₅+WO₃), that is, a total content of ZrO₂, Nb₂O₅, Ta₂O₅, and WO₃ is preferably 3.0% or more, more preferably 3.2% or more, and further preferably 3.5% or more. In the glass 10, in mole percentage on an oxide basis, (ZrO₂+Nb₂O₅+Ta₂O₅+WO₃) is preferably 15% or less, more preferably 12.5% or less, and further preferably 10% or less.

That is, it can be said that in the glass 10, in mole percentage on an oxide basis, (ZrO₂+Nb₂O₅+Ta₂O₅+WO₃) is preferably 3.0% or more and 15% or less, more preferably 3.2% or more and 12.5% or less, further preferably 3.5% or more and 10% or less, and further preferably 3.88% or more and 8.7% or less. When (ZrO₂+Nb₂O₅+Ta₂O₅+WO₃) is in this range, the glass 10 can have a high refractive index while maintaining a high transmittance with respect to visible light. However, the glass 10 may not contain at least one of ZrO₂, Nb₂O₅, Ta₂O₅, and WO₃.

(SiO₂+B₂O₃+P₂O₅)

In the glass 10, in mass percentage on an oxide basis, (SiO₂+B₂O₃+P₂O₅), that is, a total content of SiO₂, B₂O₃, and P₂O₅ is preferably 5.0% or more, more preferably 7.5% or more, and further preferably 10.0% or more. In the glass 10, in mass percentage on an oxide basis, (SiO₂+B₂O₃+P₂O₅) is preferably less than 15.0%, more preferably 15.0% or less, further preferably 14.5% or less, and further preferably 14.0% or less.

That is, it can be said that in the glass 10, in mass percentage on an oxide basis, (SiO₂+B₂O₃+P₂O₅) is preferably 5.0% or more and 15.0% or less, more preferably 7.5% or more and 14.5% or less, and further preferably 10.0% or more and 14.0% or less. When (SiO₂+B₂O₃+P₂O₅) is in this range, the glass 10 can have a high refractive index while maintaining a high transmittance with respect to visible light. However, the glass 10 may not contain at least one of SiO₂ and P₂O₅.

In the glass 10, in molar ratio on an oxide basis, a content of (SiO₂+B₂O₃+P₂O₅), that is, a total content of SiO₂, B₂O₃, and P₂O₅ is preferably larger than the content of TeO₂. When (SiO₂+B₂O₃+P₂O₅) is larger than the content of TeO₂, the glass 10 can have a high refractive index while maintaining a high transmittance with respect to visible light. In the glass 10, in mole percentage on an oxide basis, (SiO₂+B₂O₃+P₂O₅−TeO₂), that is, a value obtained by subtracting the content of TeO₂ from the total content of SiO₂, B₂O₃, and P₂O₅ is preferably more than 0%, more preferably 1.0% or more, still more preferably 2.0% or more, and even more preferably 3.0% or more. On the other hand, when (SiO₂+B₂O₃+P₂O₅−TeO₂) is 50.0% or more, the glass transition temperature Tg increases, and it becomes difficult to achieve both a high refractive index and a high transmittance. Therefore, (SiO₂+B₂O₃+P₂O₅−TeO₂) is preferably less than 50%, more preferably 46.0% or less, still more preferably 44.0% or less, and even more preferably 41.75% or less. That is, (SiO₂+B₂O₃+P₂O₅−TeO₂) is preferably more than 0% and less than 42%, more preferably 1.0% or more and 38.0% or less, further preferably 2.0% or more and 36.0% or less, and further preferably 2.3% or more and 41.75% or less.

Furthermore, in the glass 10, in molar ratio on an oxide basis, {(SiO₂+B₂O₃+P₂O₅)/TeO₂}, that is, a molar ratio of the total content of SiO₂, B₂O₃, and P₂O₅ to the content of TeO₂ is preferably 1.0 or more and 30 or less, more preferably 1.05 or more and 25 or less, further preferably 1.1 or more and 22.5 or less, and further preferably 1.1 or more and 19.55 or less.

### (Content of Fe, Cr, and Ni)

In the glass 10, a total content of Fe, Cr, and Ni is less than 4 ppm, preferably 3 ppm or less, more preferably 2 ppm or less, and further preferably 1 ppm or less, with respect to the entire glass 10 in mass ratio. Fe, Cr, and Ni do not refer to only elemental metals of Fe, Cr, and Ni contained in the glass 10, and may include elemental metals and a compound of Fe, Cr, and Ni. That is, it can be said that the total content of Fe, Cr, and Ni includes the content of elemental metals of Fe, Cr, and Ni and the content of ions of Fe, Cr, and Ni in the compound. When the total content of Fe, Cr, and Ni as coloring transition metals is in this range, a transmittance of the glass 10 with respect to visible light can be prevented from being lowered, and the glass 10 can have a high transmittance with respect to visible light. The total content of Fe, Cr, and Ni can be measured by ICP mass spectrometry. As a measuring instrument, for example, Agilent 8800 manufactured by Agilent Technologies can be used.

In the glass 10, a total content of Fe, Cr, Ni, Cu, Mn, Co, and V is preferably less than 4 ppm, more preferably 3 ppm or less, further preferably 2 ppm or less, and further preferably 1 ppm or less, with respect to the entire glass 10 in mass ratio. Similarly to Fe, Cr, and Ni described above, Fe, Cr, Ni, Cu, Mn, Co, and V described here do not refer to only elemental metals of Fe, Cr, Ni, Cu, Mn, Co, and V contained in the glass 10, and may include elemental metals and a compound of Fe, Cr, Ni, Cu, Mn, Co, and V. That is, it can be said that the total content of Fe, Cr, Ni, Cu, Mn, Co, and V includes the content of elemental metals of Fe, Cr, Ni, Cu, Mn, Co, and V and the content of ions of Fe, Cr, Ni, Cu, Mn, Co, and V in the compound. When the total content of the components described above as coloring transition metals is in this range, a transmittance of the glass 10 with respect to visible light can be prevented from being lowered, and the glass 10 can have a high transmittance with respect to visible light. The total content of the components can be measured by ICP mass spectrometry.

### (Content of Pb)

In the glass 10, a total content of Pb is preferably less than 1000 ppm, more preferably 100 ppm or less, and further preferably 10 ppm or less, with respect to the entire glass 10 in mass ratio. That is, it is preferable that the glass 10 does not substantially contain Pb. Similarly to Fe, Cr, and Ni described above, Pb does not refer to only an elemental metal of Pb contained in the glass 10, and may include an elemental metal and a compound of Pb. That is, it can be said that the content of Pb includes the content of an elemental metal of Pb and the content of ions of Pb in the compound. The content of Pb can be measured by ICP mass spectrometry.

### (Characteristics of Glass)

Characteristics of the glass 10 will be described.

### (Refractive Index n_{d})

In the glass 10, a refractive index n_{d} is preferably 1.95 or more, more preferably 1.97 or more, and further preferably 2.00 or more. When the refractive index n_{d} is in this range, a high refractive index with respect to visible light can be realized. In the glass 10, the refractive index n_{d} is preferably 2.30 or less, more preferably 2.25 or less, and further preferably 2.20 or less.

That is, it can be said that in the glass 10, the refractive index n_{d} is preferably 1.95 or more and 2.30 or less, more preferably 1.97 or more and 2.25 or less, and further preferably 2.00 or more and 2.20 or less.

The refractive index n_{d} refers to a refractive index at the d-line of helium (wavelength: 587.6 nm). The refractive index n_{d} can be measured by a V block method.

### (Wavelength λ₇₀)

A wavelength indicating an internal transmittance of 70% with a plate thickness (thickness) of 10 mm is defined as a wavelength λ₇₀. That is, the wavelength λ₇₀ refers to a wavelength of light at which the internal transmittance is 70% with respect to a sample having a thickness of 10 mm. The wavelength λ₇₀ of the glass 10 with a plate thickness (thickness) of 10 mm is preferably less than 450 nm, more preferably 445 nm or less, and further preferably 440 nm or less. The wavelength λ₇₀ of the glass 10 is preferably 390 nm or more, more preferably 395 nm or more, and further preferably 400 nm or more.

That is, it can be said that the wavelength λ₇₀ of the glass 10 is preferably 390 nm or more and less than 450 nm, more preferably 395 nm or more and 445 nm or less, and further preferably 400 nm or more and 440 nm or less.

When the wavelength λ₇₀ is in this range, a high transmittance with respect to visible light can be realized. The internal transmittance for calculating the wavelength λ₇₀ can be determined from measurement values of two types of external transmittance with different plate thicknesses and the following Formula (1). The external transmittance means a transmittance including a surface reflection loss. In Formula (1), X is the internal transmittance of the glass having a thickness of 10 mm, T1 and T2 are external transmittance, and Δd is a difference between thicknesses of samples. The external transmittance can be measured by using a spectrophotometer (U-4100 manufactured by Hitachi High-Tech Corporation) for a sample both surfaces of which are mirror-polished to have a plate thickness of 10 mm.

$$log X = - \frac{log T 1 - log T 2}{Δ d} \times 10 \qquad ( 1 )$$

### (Transmittance of Light)

In the glass 10, an internal transmittance of light at a wavelength of 450 nm with a plate thickness (thickness) of 10 mm is preferably 84% or more, preferably 85% or more, and further preferably 86% or more.

When the internal transmittance of light at a wavelength of 450 nm is in this range, a high transmittance with respect to visible light can be realized. The internal transmittance of the glass having a thickness of 10 mm can be determined from measurement values of two types of external transmittance with different plate thicknesses and Formula (1).

### (Glass Transition Temperature)

In the glass 10, the glass transition temperature Tg is preferably 500° C. or lower, more preferably 480° C. or lower, and further preferably 460° C. or lower. In the glass 10, the glass transition temperature Tg is preferably 326° C. or higher, more preferably 380° C. or higher, and further preferably 400° C. or higher.

That is, in the glass 10, the glass transition temperature Tg is preferably 326° C. or higher and 500° C. or lower, more preferably 380° C. or higher and 480° C. or lower, and further preferably 400° C. or higher and 460° C. or lower.

When the glass transition temperature Tg is in this range, for example, the heating temperature in reheat press molding (molding in which pressure is applied while heating) can be lowered, which is preferable.

The glass transition temperature Tg was a value measured using TMA and was determined according to the standard of JIS R3103-3 (2001).

### (Abbe Number)

In the glass 10, an Abbe number V_{d} is preferably 17 or more, more preferably 17.1 or more, and further preferably 17.2 or more. In the glass 10, the Abbe number V_{d} is preferably less than 25.0, more preferably 24.0 or less, and further preferably 23.0 or less.

That is, it can be said that in the glass 10, the Abbe number V_{d} is preferably 17 or more and less than 25.0, more preferably 17.1 or more and 24.0 or less, and further preferably 17.2 or more and 23.0 or less.

When the Abbe number V_{d} is in this range, color dispersion can be appropriately suppressed. The Abbe number V_{d} can be calculated based on the refractive index n_{c} (refractive index at the c-line of helium), the refractive index n_{d}, and the refractive index n_{F}(refractive index at the F-line of helium) measured by a V block method.

### (Form of Glass)

The glass 10 according to the present embodiment is preferably an optical glass, and is preferably a glass plate having a thickness of 0.01 mm or more and 2.0 mm or less. When the thickness is 0.01 mm or more, the glass 10 can be prevented from being damaged at the time of handling or processing. The deflection of the glass 10 caused by its own weight can be suppressed. The thickness is more preferably 0.1 mm or more, further preferably 0.2 mm or more, and still more preferably 0.3 mm or more. On the other hand, when the thickness is 2.0 mm or less, a weight of an optical element using the glass 10 can be reduced. The thickness is more preferably 1.5 mm or less, further preferably 1.0 mm or less, and still more preferably 0.8 mm or less.

When the glass 10 according to the present embodiment is a glass plate, an area of a principal surface is preferably 8 cm² or more. When the area is 8 cm² or more, a large number of optical elements can be disposed to improve productivity. The area is more preferably 30 cm² or more, further preferably 170 cm² or more, still more preferably 300 cm² or more, and particularly preferably 1000 cm² or more. On the other hand, when the area is 6500 cm² or less, handling of the glass plate becomes easy, and the glass plate can be prevented from being damaged at the time of handling or processing. The area is more preferably 4500 cm² or less, further preferably 4000 cm² or less, still more preferably 3000 cm² or less, and particularly preferably 2000 cm² or less.

When the glass 10 according to the present embodiment is a glass plate, a local thickness variation (LTV) in 25 cm² of a principal surface is preferably 2 m or less. Flatness in this range enables to form a nanostructure with a desired shape on a principal surface by using an imprinting technique or the like, and to obtain desired light guide characteristics. In particular, a ghost phenomenon and distortion due to a difference in optical lengths can be prevented in a light guide. The LTV is more preferably 1.5 μm or less, further preferably 1.0 m or less, and particularly preferably 0.5 μm or less.

When the glass 10 according to the present embodiment is a circular glass plate with a diameter of 8 inches, warpage thereof is preferably 50 μm or less. When the warpage of the glass 10 is 50 μm or less, a nanostructure with a desired shape can be formed on a principal surface by using an imprinting technique or the like, and desired light guide characteristics are obtained. When a plurality of light guides are to be obtained, stable quality is obtained. The warpage of the glass 10 is more preferably 40 μm or less, further preferably 30 μm or less, and particularly preferably 20 μm or less.

When the glass 10 according to the present embodiment is a circular glass plate with a diameter of 6 inches, warpage thereof is preferably 30 μm or less. When the warpage of the glass 10 is 30 μm or less, a nanostructure with a desired shape can be formed on a principal surface by using an imprinting technique or the like, and desired light guide characteristics are obtained. When a plurality of light guides are to be obtained, stable quality is obtained. The warpage of the glass 10 is more preferably 20 μm or less, further preferably 15 μm or less, and particularly preferably 10 μm or less.

When the glass 10 according to the present embodiment is a square glass plate having each side of 6 inches, warpage thereof is preferably 100 μm or less. When the warpage of the glass 10 is 100 μm or less, a nanostructure with a desired shape can be formed on a principal surface by using an imprinting technique or the like, and desired light guide characteristics are obtained. When a plurality of light guides are to be obtained, stable quality is obtained. The warpage of the glass 10 is more preferably 70 μm or less, further preferably 50 μm or less, further preferably 35 μm or less, and particularly preferably 20 μm or less.

FIG. 2 is a cross-sectional view assuming that the glass according to the present embodiment is a glass plate. When the glass 10 according to the present embodiment is a glass plate G1, “warpage” is a difference C between a maximum value B and a minimum value A of a distance between a reference line G1D of the glass plate G1 and a center line G1C of the glass plate G1 in a vertical direction at an arbitrary cross-section which passes a center of a principal surface G1F of the glass plate G1 and is orthogonal to the principal surface G1F of the glass plate G1.

An intersection line between the orthogonal arbitrary cross-section and the principal surface G1F of the glass plate G1 is defined as a base line G1A. An intersection line between the orthogonal arbitrary cross-section and other principal surface G1G of the glass plate G1 is defined as an upper line G1B. The center line G1C is a line connecting each center in a plate thickness direction of the glass plate G1. The center line G1C is calculated by determining a midpoint between the base line G1A and the upper line G1B with respect to a laser irradiation direction described below.

The reference line G1D is determined as follows. First, the base line G1A is calculated based on a measuring method in which effect due to its own weight is canceled. A straight line is determined by a least squares method from the base line G1A. The determined straight line is the reference line G1D. As the measuring method in which effect due to its own weight is canceled, a known method is used.

For example, the principal surface G1F of the glass plate G1 is three-point supported, then laser is irradiated on the glass plate G1 by a laser displacement gauge, and heights of the principal surface G1F and the other principal surface G1G of the glass plate G1 are measured from an arbitrary reference plane.

Next, the glass plate G1 is reversed, then three points of the other principal surface G1G opposing to the three points which have supported one principal surface G1F are supported, and heights of the principal surface G1F and the other principal surface G1G of the glass plate G1 are measured from the arbitrary reference plane.

The effect due to its own weight is canceled by determining averages of heights at respective measurement points before and after the reverse. For example, the height of the principal surface G1F is measured before the reverse as described above. After the glass plate G1 is reversed, the height of the other principal surface G1G is measured at a position corresponding to the measurement point of the principal surface G1F. Similarly, the height of the other principal surface G1G is measured before the reverse. After the glass plate G1 is reversed, the height of the principal surface G1F is measured at a position corresponding to the measurement point of the other principal surface G1G.

Warpage is measured by, for example, the laser displacement gauge.

In the glass 10 according to the present embodiment, surface roughness Ra of the principal surface is preferably 2 nm or less. The Ra in this range enables to form a nanostructure with a desired shape on a principal surface by using an imprinting technique or the like, and to obtain desired light guide characteristics. In particular, irregular reflection at an interface is suppressed in the light guide, and a ghost phenomenon and distortion can be prevented. The Ra is more preferably 1.7 nm or less, further preferably 1.4 nm or less, still more preferably 1.2 nm or less, and particularly preferably 1 nm or less. The surface roughness Ra is arithmetic mean roughness defined in JIS B0601 (2001). In the present specification, the surface roughness Ra is a value obtained by measuring an area of 10 μm×10 μm by using an atomic force microscope (AFM).

### (Method for Producing Glass)

A method for producing the glass 10 according to the present embodiment is not particularly limited, and a known method for producing a plate glass can be used. For example, a known method such as a float method, a fusion method, or a roll-out method can be used. However, in order to suppress deterioration of the transmittance of the glass 10 caused by mixing of impurities, Au and an Au alloy are preferably used as a material of a vessel (crucible) in which raw materials are put at the time of melting the raw materials.

For the glass 10 of the present embodiment, it is preferable to perform an operation of increasing an amount of moisture in molten glass in a melting process of heating and melting glass raw materials in a melting vessel to obtain the molten glass. The operation of increasing the amount of moisture in the glass is not limited, and for example, the operation may be processing of adding water vapor to melting atmosphere, and processing of bubbling gas containing water vapor into a molten material. The operation of increasing the amount of moisture is not essential, but can be performed for the purpose of improving transmittance, improving clarity, and the like.

The glass 10 of the present embodiment containing an alkali metal oxide such as Li₂O or Na₂O can be chemically strengthened by substituting a Na ion or a K ion for a Li ion, and substituting a K ion for a Na ion. That is, the strength of the optical glass can be improved by chemical strengthening processing.

### (Effects)

As described above, the glass 10 according to the present embodiment contains, in weight percentage on an oxide basis:
Bi₂O₃: 5.0% to 80.0%;
B₂O₃: 1.0% to 15.0%;
TiO₂: 0% to 7.0%;
Nb₂O₅: 0% to 17.0%; and
TeO₂: 0% to 30.0%,
in which a content of (Li₂O+Na₂O+K₂O) is 0% to 5.0%.

Due to such a composition, the glass 10 is enabled to have a high refractive index while maintaining a high transmittance with respect to visible light. Due to such a composition, the glass transition temperature Tg can be set to a low temperature such as 500° C. or lower, and appropriate molding can be performed. For example, in order to efficiently produce the glass 10, it is effective to cut out a plurality of pieces of the glass 10 from a glass base material. In this case, by increasing the area by subjecting the glass base material to reheat press molding, the number of pieces of the glass 10 to be cut out is increased, and more efficient production can be performed. In this case, when the glass transition temperature Tg is high, it is necessary to increase the heating temperature in the reheat press molding, and problems may arise, for example, in that a takt becomes longer, a reaction between the glass base material and a mold easily occurs, a metal is deposited, and fusion with a mold easily occurs. On the other hand, in the present embodiment, by setting the glass 10 to the above composition, the glass transition temperature Tg can be lowered to suppress the occurrence of these problems, and the reheat press molding can be appropriately performed. As described above, it can be said that the glass 10 according to the present embodiment has a high refractive index and a high transmittance and can be appropriately molded. A numerical range represented by “to” means a numerical range including numerical values before and after “to” as a lower limit value and an upper limit value, and when “to” is used in the following description, the same meaning is given.

In the glass 10, in molar ratio on an oxide basis, a content of (ZrO₂+Nb₂O₅+Ta₂O₅+WO₃) is preferably 5% or more. Accordingly, a high refractive index, a high transmittance, and moldability can be more suitably realized.

In the glass 10, in weight percentage on an oxide basis, the content of (SiO₂+B₂O₃+P₂O₅) is preferably less than 15%. Accordingly, a high refractive index, a high transmittance, and moldability can be more suitably realized.

In the glass 10, in molar ratio on an oxide basis, the content of (SiO₂+B₂O₃+P₂O₅) is preferably larger than the content of TeO₂. Accordingly, a high refractive index, a high transmittance, and moldability can be more suitably realized.

In the glass 10, a total content of Fe, Cr, and Ni is preferably smaller than 4 ppm by mass. Accordingly, a high refractive index, a high transmittance, and moldability can be more suitably realized.

In the glass 10, it is preferable that a refractive index is 1.95 or more, a wavelength λ₇₀ indicating an internal transmittance of 70% with a plate thickness of 10 mm is less than 450 nm, and a glass transition temperature Tg is 500° C. or lower. Accordingly, a high refractive index, a high transmittance, and moldability can be more suitably realized.

In the glass 10, it is preferable that an internal transmittance of light at a wavelength of 450 nm with a plate thickness of 10 mm is 85% or more. Accordingly, a high refractive index, a high transmittance, and moldability can be more suitably realized.

In the glass 10, an Abbe number is preferably 17 or more and less than 25. Accordingly, a high refractive index, a high transmittance, and moldability can be more suitably realized.

The glass 10 is preferably used as a light guide plate. Since the glass 10 has a high refractive index and a high transmittance, the glass 10 is appropriately used as a light guide plate.

### EXAMPLES

Next, Examples will be described. The embodiment may be modified as long as the effect of the invention is exhibited.

In Examples, pieces of glass respectively having different compositions were produced. The refractive index, the transmittance, and the glass transition temperature Tg of each glass were evaluated. Hereinafter, description will be given in more detail.

Tables 1 and 2 are tables showing materials used for glass in Examples. Tables 1 and 2 show, for each example, the content of the material used for producing glass in weight percentage on an oxide basis.

TABLE 1

| | | Example | Example | Example | Example | Example | Example | Example | Example | Example |
|---|---|---|---|---|---|---|---|---|---|---|
| | | 1 | 2 | 3 | 4 | 5 | 6 | 7 | 8 | 9 |
| Composition | B₂O₃ | 6.40 | 6.42 | 6.38 | 6.34 | 6.48 | 6.44 | 5.90 | 7.70 | 9.00 |
| (wt %) | P₂O₅ | 5.85 | 5.87 | 5.84 | 5.80 | 5.93 | 5.89 | 6.30 | 4.60 | 3.80 |
| | Li₂O | | | | | 0.06 | | | | |
| | Na₂O | | | | | 0.13 | | | | |
| | K₂O | | | | | 0.20 | | | | |
| | ZnO | 2.21 | 1.87 | 1.86 | 1.85 | 1.89 | 1.88 | 3.20 | 1.60 | 1.50 |
| | ZrO₂ | | | | | | 1.06 | 0.30 | 0.40 | 1.10 |
| | La₂O₃ | | | | | | | | | |
| | TiO₂ | | 0.69 | 0.34 | | | 0.69 | | | |
| | Nb₂O₅ | 7.59 | 7.62 | 7.57 | 7.53 | 7.69 | 7.64 | 5.30 | 5.70 | 3.90 |
| | WO₃ | | | | | | | | | |
| | Bi₂O₃ | 60.56 | 60.78 | 60.41 | 60.05 | 61.37 | 60.97 | 60.00 | 62.00 | 64.00 |
| | TeO₂ | 17.38 | 16.76 | 16.66 | 16.56 | 16.23 | 15.44 | 19.00 | 18.00 | 16.70 |
| | Ta₂O₅ | | | 0.94 | 1.87 | | | | | |
| | SiO₂ | | | | | | | | | |
| | SrO | | | | | | | | | |
| Total content | SiO₂ + B₂O₃ + P₂O₅ | 12.2 | 12.3 | 12.2 | 12.1 | 12.4 | 12.3 | 12.2 | 12.3 | 12.8 |
| (wt %) | | | | | | | | | | |
| Total content | ZrO₂ + Nb₂O₅ + | 6.7 | 6.7 | 7.2 | 7.8 | 6.8 | 8.7 | 5.1 | 5.7 | 5.4 |
| (mol %) | Ta₂O₅ + WO₃ | | | | | | | | | |
| Content ratio | (SiO₂ + B₂O₃ + | 5.7 | 6.7 | 6.7 | 6.7 | 7.8 | 8.7 | 2.3 | 7.0 | 11.7 |
| (mol %) | P₂O₅ − TeO₂) | | | | | | | | | |
| Content ratio | {(SiO₂ + B₂O₃ + | 1.2 | 1.3 | 1.3 | 1.3 | 1.3 | 1.4 | 1.1 | 1.3 | 1.5 |
| (molar ratio) | P₂O₅)/TeO₂} | | | | | | | | | |
| Evaluation | Refractive index n_{d} | 2.1023 | 2.1084 | 2.1057 | 2.1029 | 2.1013 | 2.1075 | 2.1039 | 2.0999 | 2.0904 |
| | Wavelength λ₇₀ (nm) | 416 | 423 | 420 | 417 | 418 | 423 | 411 | 418 | 422 |
| | Glass transition | 430 | 434 | 435 | 435 | 426 | 450 | 442 | 416 | 403 |
| | temperature Tg (° C.) | | | | | | | | | |
| | Abbe number νd | 19.1 | 18.9 | 19.2 | 19.4 | 18.8 | 19.0 | 19.3 | 18.8 | 18.1 |
| | Wavelength λ₅ (nm) | 393 | 399 | 396 | 393 | 394 | 399 | 394 | 397 | 404 |
| | T % at 450 nm | 95 | 94 | 94 | 95 | 95 | 94 | 96 | 95 | 97 |

TABLE 2

| | | Example | Example | Example | Example | Example | Example | Example | Example | Example |
|---|---|---|---|---|---|---|---|---|---|---|
| | | 10 | 11 | 12 | 13 | 14 | 15 | 16 | 17 | 18 |
| Composition | B₂O₃ | 7.30 | 8.00 | 8.10 | 9.30 | 9.41 | 9.83 | 9.42 | 10.37 | 8.38 |
| (wt %) | P₂O₅ | 5.50 | 2.00 | 6.80 | | | | | | |
| | Li₂O | | 0.60 | | 1.38 | 1.39 | 1.10 | 1.09 | 1.16 | 1.28 |
| | Na₂O | | | | | | | | | |
| | K₂O | | | | | | | | | |
| | ZnO | 2.30 | 3.20 | 2.10 | 3.00 | 3.04 | 2.24 | 2.22 | 2.37 | 2.10 |
| | ZrO₂ | 2.80 | 2.10 | 1.90 | 2.27 | 2.30 | 2.25 | 2.23 | 2.37 | |
| | La₂O₃ | | 1.00 | | 4.50 | 6.08 | 4.46 | 4.42 | 4.71 | |
| | TiO₂ | 1.10 | 0.60 | 1.00 | 0.74 | | 0.73 | 0.72 | 0.77 | 0.69 |
| | Nb₂O₅ | 3.90 | 1.60 | 1.90 | | | | | | |
| | WO₃ | | 0.30 | | | | | | | |
| | Bi₂O₃ | 57.00 | 68.00 | 67.00 | 75.10 | 73.86 | 74.49 | 73.84 | 69.46 | 84.08 |
| | TeO₂ | 19.60 | 12.60 | 11.20 | | | 1.49 | 2.95 | 5.49 | |
| | Ta₂O₅ | 0.50 | | | | | | | | |
| | SiO₂ | | | | 2.77 | 3.92 | 2.46 | 2.16 | 2.30 | 2.71 |
| | SrO | | | | 0.95 | | 0.95 | 0.94 | 1.00 | 0.93 |
| Total content | SiO₂ + B₂O₃ + P₂O₅ | 12.8 | 10.0 | 14.9 | 12.1 | 13.3 | 12.3 | 11.6 | 12.7 | 11.1 |
| (wt %) | | | | | | | | | | |
| Total content | ZrO₂ + Nb₂O₅ + | 8.2 | 5.4 | 5.1 | 3.9 | 3.9 | 3.9 | 3.9 | 3.9 | 0.0 |
| (mol %) | Ta₂O₅ + WO₃ | | | | | | | | | |
| Content ratio | (SiO₂ + B₂O₃ + | 4.4 | 11.2 | 21.4 | 37.9 | 41.7 | 37.1 | 33.1 | 31.1 | 38.0 |
| (mol %) | P₂O₅ − TeO₂) | | | | | | | | | |
| Content ratio | {(SiO₂ + B₂O₃ + | 1.2 | 1.6 | 2.3 | | | 19.6 | 9.3 | 5.4 | |
| (molar ratio) | P₂O₅)/TeO₂} | | | | | | | | | |
| Evaluation | Refractive index n_{d} | 2.0793 | 2.1275 | 2.0506 | 2.0719 | 2.0532 | 2.0774 | 2.0857 | 2.0558 | 2.1262 |
| | Wavelength λ₇₀ (nm) | 423 | 429 | 431 | 438 | 433 | 435 | 436 | 431 | 480 |
| | Glass transition | 451 | 445 | 387 | 343 | 327 | 348 | 360 | 327 | 365 |
| | temperature Tg (° C.) | | | | | | | | | |
| | Abbe number νd | 19.5 | 17.7 | 17.8 | 18.5 | 19.4 | 18.5 | 18.2 | 19.1 | 17 |
| | Wavelength λ₅ (nm) | 393 | 410 | 412 | 416 | 411 | 415 | 416 | 410 | 430 |
| | T % at 450 nm | 96 | 91 | 91 | 86 | 90 | 90 | 89 | 92 | 70 |

In Examples, pieces of glass respectively having thicknesses of 10 mm and 1 mm were produced with compositions described in the respective examples in Tables 1 and 2. The pieces of glass produced as described above were used as samples to perform evaluation. Specifically, raw materials with compositions shown in Tables 1 and 2 were uniformly mixed, and molten for 2 hours in a gold crucible at 950° C. to be uniform molten glass. Next, the molten glass was poured into a mold made of carbon having a size of length×width×height=length 60 mm×width 50 mm×height 30 mm. Thereafter, the molten glass was held for 1 hour at 430° C. and cooled to room temperature at a temperature decreasing rate of about 1° C./min to obtain a glass block. Next, the glass block was cut to have a size of length×width=30 mm×30 mm using a cutting machine (compact cutting machine manufactured by MARUTO INSTRUMENT CO., LTD.), and adjustment of a plate thickness and surface polishing were performed thereon using a grinding machine (SGM-6301 manufactured by Shuwa Industry co., ltd.) and a single-side polishing machine (EJ-380IN manufactured by Engis Japan Corporation) to produce glass plates each having a size of length×width=30 mm×30 mm and having a plate thicknesses of 10 mm and 1 mm.

### (Evaluation)

For the pieces of glass in the respective examples, a refractive index and a transmittance with respect to visible light and the glass transition temperature Tg were evaluated. In evaluation of the refractive index, the refractive index n_{d} at the d-line of helium (wavelength: 587.6 nm) was measured for each piece of the glass. For the measurement of the refractive index n_{d}, KPR-2000 manufactured by Kalnew was used. In evaluation of the refractive index, the refractive index n_{d} of 1.95 or more was accepted, and the refractive index n_{d} of less than 1.95 was rejected.

In evaluation of the transmittance, the wavelength λ₇₀ indicating an external transmittance of 70% with a plate thickness of 10 mm was measured for each piece of the glass. For the measurement of the wavelength λ₇₀, U-4100 manufactured by Hitachi High-Tech Corporation was used. In evaluation of the transmittance, the wavelength λ₇₀ of less than 450 nm was accepted, and the wavelength λ₇₀ of 450 nm or more was rejected.

The glass transition temperature Tg was a value measured using TMA and was determined according to the standard of JIS R3103-3 (2001). In evaluation of the glass transition temperature Tg, the temperature of 500° C. or lower was accepted, and the temperature of higher than 500° C. was rejected.

### (Evaluation Results)

As shown in Tables 1 and 2, it is found that, in examples 1 to 17 as Examples, all of the refractive index n_{d}, the wavelength λ₇₀, and the glass transition temperature Tg are accepted, and a high refractive index, a high transmittance, and moldability can be realized. It is found that, in example 18 as Comparative Example in which the content of Bi₂O₃ is more than 80%, at least one of the refractive index n_{d}, the wavelength λ₇₀, and the glass transition temperature Tg is rejected, and a high refractive index, a high transmittance, and moldability cannot be realized.

As optional evaluation, the Abbe number v_{d}, the wavelength λ₅, and the internal transmittance of light at a wavelength of 450 nm were measured. The optional evaluation results are shown in Tables 1 and 2.

The Abbe number V_{d} was calculated based on the refractive index n_{c}, the refractive index n_{d}, and the refractive index n_{f} measured using KPR-2000 manufactured by Kalnew.

For the measurement of the wavelength λ₅ indicating an external transmittance of 5% with a plate thickness of 10 mm, U-4100 manufactured by Hitachi High-Tech Corporation was used.

The internal transmittance of light at a wavelength of 450 nm was calculated from measurement values of two types of external transmittance with different plate thicknesses measured using U-4100 manufactured by Hitachi High-Tech Corporation and Formula (1).

Although the embodiment of the present invention has been described, the embodiment is not limited by the contents of the embodiment. The constituent elements described above include a constituent element that is easily conceivable by those skilled in the art, substantially the same constituent element, and what is called an equivalent. The constituent elements described above can be appropriately combined. The constituent elements can be variously omitted, replaced, or modified without departing from the gist of the embodiment described above.

### REFERENCE SIGNS LIST

10 GLASS

1. Glass comprising, in weight percentage on an oxide basis:
Bi₂O₃: 5.0% to 80.0%;
B₂O₃: 1.0% to 15.0%;
TiO₂: 0% to 7.0%;
Nb₂O₅: 0% to 17.0%; and
TeO₂: 0% to 30.0%, wherein
a content of (Li₂O+Na₂O+K₂O) is 0% to 5.0%.

2. The glass according to claim 1, wherein a content of (ZrO₂+Nb₂O₅+Ta₂O₅+WO₃) is 3.5% or more in mole percentage on an oxide basis.

3. The glass according to claim 1, wherein a content of (SiO₂+B₂O₃+P₂O₅) is less than 15% in weight percentage on an oxide basis.

4. The glass according to claim 1, wherein a content of (SiO₂+B₂O₃+P₂O₅) is larger than a content of TeO₂ in molar ratio on an oxide basis.

5. The glass according to claim 1, wherein a total content of Fe, Cr, and Ni is smaller than 4 ppm by mass.

6. The glass according to claim 1, wherein a refractive index is 1.95 or more, a wavelength λ₇₀ indicating an internal transmittance of 70% with a plate thickness of 10 mm is less than 450 nm, and a glass transition temperature Tg is 500° C. or lower.

7. The glass according to claim 1, wherein an internal transmittance of light at a wavelength of 450 nm with a plate thickness of 10 mm is 85% or more.

8. The glass according to claim 1, wherein an Abbe number is 17 or more and less than 25.

9. The glass according to claim 1, which is used as a light guide plate.
